(19) United States
(12) Patent Application Publication
(10) Pub. No.: US 2007/0197094 A1
(43) Pub. Date: Aug. 23, 2007

(54) Contacts For Use In Monitoring Connection Patterns In Data Ports

(75) Inventor: Frank Velleca, Woodbury, CT (US)

Correspondence Address: CANTOR COLBURN, LLP, 55 GRIFFIN ROAD SOUTH, BLOOMFIELD, CT, 06002, US

(73) Assignee: THE SIEMON COMPANY, Watertown, CT (US)

(21) Appl. No.: 11/672,657

(22) Filed: Feb. 8, 2007

Related U.S. Application Data
(60) Provisional application No. 60/771,575, filed on Feb. 8, 2006.

(51) Int. Cl. H01R 13/648

(52) U.S. Cl. 439/607

(57) ABSTRACT

A plug includes a plug housing; a plug boot surrounding the plug housing; a cable passing through the plug boot; a contact pad being placed in electrical connection with an outlet contact in a connectivity detection system; a sensing conductor electrically connected to the contact pad, the sensing conductor running along the cable.

### CROSS-REFERENCE TO RELATED APPLICATIONS

This application claims the benefit of U.S. provisional patent application Ser. No. 60/771,575 filed Feb. 8, 2006, the entire contents of which are incorporated herein by reference.

### BACKGROUND

Patch panels are often used to provide an interconnection between telecommunication outlets and active equipment. One difficulty experienced with patch panels is knowing which port of the patch panel is connected to which port on the active equipment. One solution to this problem is disclosed in U.S. Pat. No. 6,574,586, the entire contents of which are incorporated herein by reference. U.S. Pat. No. 6,574,586 discloses a system in which an adapter jacket having an external contact is placed on the plug. Outlets include an adapter board having a socket contact also referred to as an outlet contact. The socket contacts are wired to an analyzer that then can determine which sockets are connected by patch cords by applying a signal to each socket contact. Pending U.S. patent application Ser. No. 11/037,859, the entire contents of which are incorporated herein by reference, describes a patch panel system in which a screen is provided on a plug to make electrical contact with a conductive tab at an outlet. This electrical connection allows port-to-port connectivity to be monitored.

In the system of U.S. Pat. No. 6,574,586, the spring-loaded pin provided on the plug boot has drawbacks. One problem with the spring-loaded pin is that it is difficult to captivate in relation to the RJ45 or fiber connector. Current methods used to captivate the spring-loaded pin include an overmolded boot, a clip on boot or a boot designed specifically to work with the spring-loaded. These methods are more difficult to assemble than standard patch cords.

Another problem is that the spring-loaded pin is susceptible to damage during manufacture, use, storage and shipping. If the plunger of the spring-loaded pin is bent even slightly it will not function properly. In such a situation the customer would have to replace the cord. The conductor used with patch cords (copper or fiber) must be terminated to the spring-loaded pin. Current methods include soldering or using and IDC which can render manufacturing more difficult.

### SUMMARY OF THE INVENTION

An embodiment of the invention includes a plug comprising a plug housing; a plug boot surrounding the plug housing; a cable passing through the plug boot; a contact pad being placed in electrical connection with an outlet contact pad in a connectivity detection system; a sensing conductor electrically connected to the contact pad, the sensing conductor running along the cable.

### BRIEF DESCRIPTION OF THE DRAWINGS

FIG. 1 illustrates a contact pad in an embodiment of the invention.

FIG. 2 illustrates a contact pad in an alternate embodiment of the invention.

FIG. 3 illustrates a contact pad in an alternate embodiment of the invention.

FIG. 4 illustrates a contact pad in an alternate embodiment of the invention.

FIG. 5 illustrates a contact pad in an alternate embodiment of the invention.

FIG. 6 illustrates a contact pad in an alternate embodiment of the invention.

FIG. 7 illustrates an outlet contact in a connectivity detection system.

### DETAILED DESCRIPTION

FIG. 1 illustrates a connector 10 in an embodiment of the invention. Connector 10 is an RJ45 plug, having contacts 11 for engaging contacts in an outlet (not shown). It is understood that embodiments of the invention are not limited to copper RJ45 connectors, and may be used with different types of electrical connectors and/or fiber optic connectors. The plug housing 12 supports the contacts 11 and receives a cable 13 having wires making electrical connection with contacts 11. A sensing conductor 14 is used to carry a monitoring signal for detecting connectivity as described in U.S. patent application Ser. No. 11/037,859. Sensing conductor 14 may be a wire or a cable shield of cable 13.

A contact pad 15 is a conductive member (e.g., copper) secured to the plug housing 12 and electrically connected to sensing conductor 14. The contact pad 15 may be formed from a bent piece of conductive sheet material and secured to the plug housing 12 by wrapping the contact pad 15 around the plug housing. Mechanical features on the contact pad (e.g., prongs) may be used to secure the contact pad 15 to the plug housing.

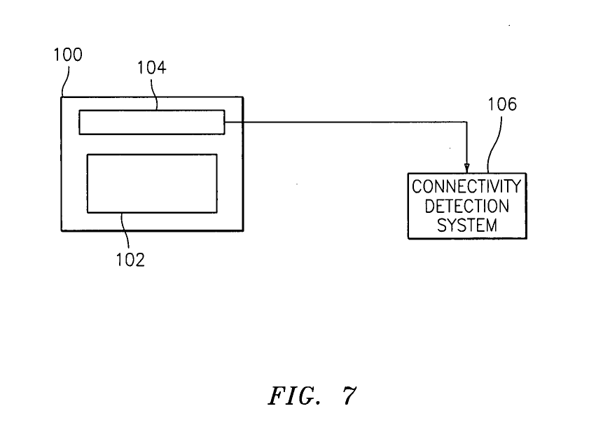

The contact pad 15 is electrically connected to sensing conductor 14 through known techniques such as crimping, soldering, an insulation displacement contact (IDC), etc. Integrally formed with the contact pad 15 is an extension 16, which is a z-shaped element. Extension 16 makes electrical contact with an outlet contact pad (FIG. 7) used in the connectivity detection systems. Extension 16 is sized and shaped to provide a spring force so that when the plug 10 is mated with an outlet, extension 16 applies a spring force to maintain physical and electrical contact with the outlet contact pad.

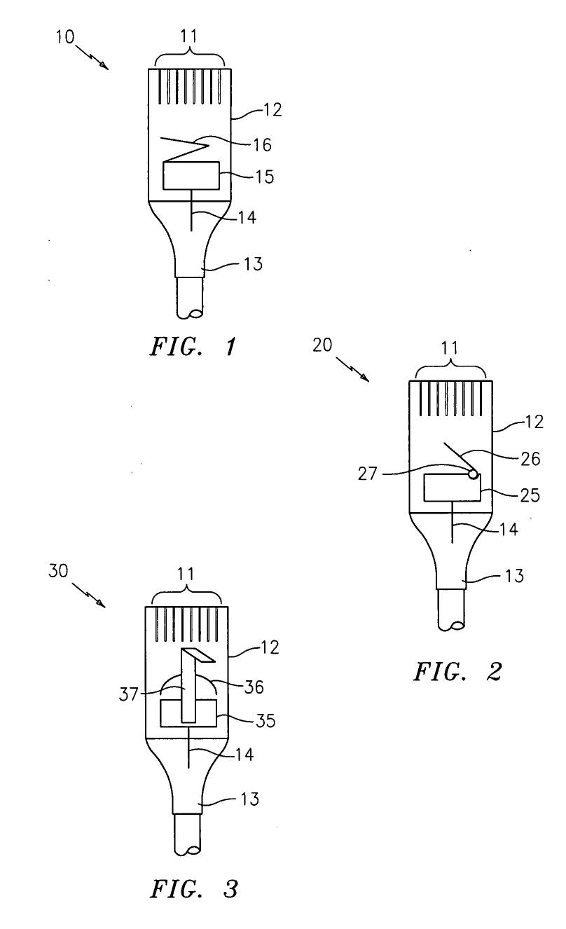

FIG. 2 illustrates a contact pad 25 in an alternate embodiment of the invention. Contact pad 25 is a conductive member (e.g., copper) secured to the plug housing 12 and electrically connected to sensing conductor 14. The contact pad 25 may be formed from a bent piece of conductive sheet material and secured to the plug housing 12 by wrapping the contact pad 25 around the plug housing. Mechanical features on the contact pad (e.g., prongs) may be used to secure the contact pad 25 to the plug housing.

The contact pad 25 is electrically connected to sensing conductor 14 through known techniques such as crimping, soldering, an IDC, etc. Integrally formed with the contact pad 25 is a coil 27 and an extension 26. Extension 26 makes electrical contact with an outlet contact pad (FIG. 7) used in the connectivity detection systems. Extension 26 and coil 27 are sized and shaped to provide a spring force so that when the plug 20 is mated with an outlet, extension 26 applies a spring force to maintain physical and electrical contact with the outlet contact pad.

FIG. 3 illustrates a contact pad 35 in an alternate embodiment of the invention. Contact pad 35 is a conductive member (e.g., copper) secured to the plug housing 12 and electrically connected to sensing conductor 14. The contact pad 35 may be formed from a bent piece of conductive sheet material and secured to the plug housing 12 by wrapping the contact pad 35 around the plug housing. Mechanical features on the contact pad (e.g., prongs) may be used to secure the contact pad 35 to the plug housing.

The contact pad 35 is electrically connected to sensing conductor 14 through known techniques such as crimping, soldering, an IDC, etc. Conductive arms 36 are in electrical contact with contact pad 35 through conductive member 37. Conductive arms 36 and conductive member 37 may be formed from conductive sheet material (e.g., copper). Conductive arms 36 move relative to plug body 12, while maintaining electrical contact with contact pad 35 through conductive member 37. Arms 36 may travel in a channel formed on the plug housing 12. When the plug 30 is mated with an outlet, the metal arms are then slid by the user towards contacts 11, to make electrical contact with an outlet contact pad (FIG. 7) used in connectivity detection systems. Arms 36 are sized and shaped to provide a spring force so that when the plug 30 is mated with an outlet, and arms 36 slid forward, arms 36 apply a spring force to maintain physical and electrical contact with the outlet contact pad.

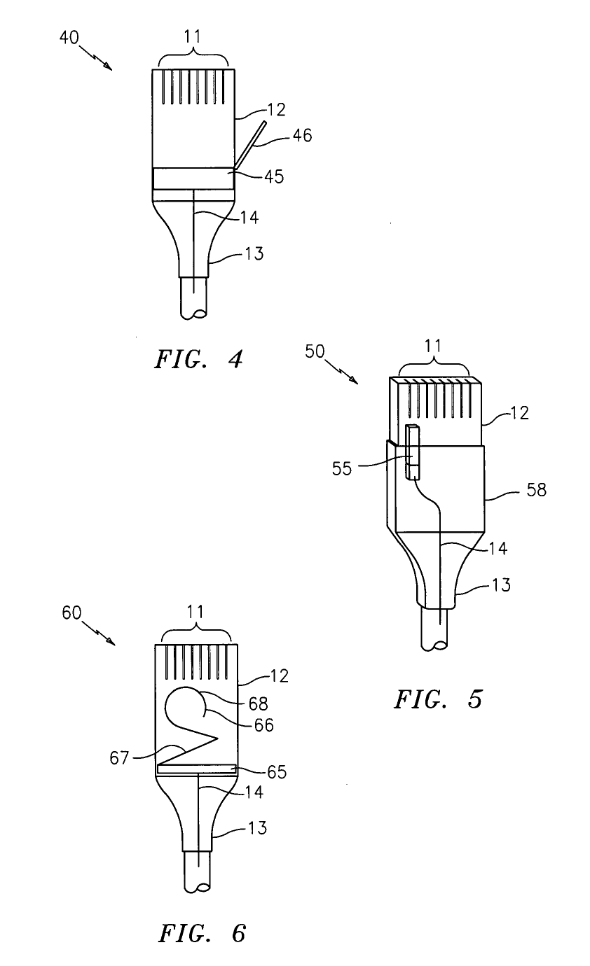

FIG. 4 illustrates a contact pad 45 in an alternate embodiment of the invention. Contact pad 45 is a conductive member (e.g., copper) secured to the plug housing 12 and electrically connected to sensing conductor 14. The contact pad 45 may be formed from a bent piece of conductive sheet material and secured to the plug housing 12 by wrapping the contact pad 45 around the plug housing. Mechanical features on the contact pad (e.g., prongs) may be used to secure the contact pad 45 to the plug housing.

The contact pad 45 is electrically connected to sensing conductor 14 through known techniques such as crimping, soldering, an IDC, etc. Integrally formed with the contact pad 45 is an extension 46. In contrast with prior embodiments, extension 46 is positioned on the side of plug body 12 rather than on top. Extension 46 makes electrical contact with an outlet contact pad (FIG. 7) used in connectivity detection systems. Extension 46 is sized and shaped to provide a spring force so that when the plug 40 is mated with an outlet, extension 46 applies a spring force to maintain physical and electrical contact with the outlet contact pad.

FIG. 5 illustrates a contact pad 55 in an alternate embodiment of the invention. Contact pad 55 is a conductive member (e.g., copper) secured to the plug boot 58 and electrically connected to sensing conductor 14. In this embodiment, the contact pad 55 is fixed to a plug boot 58, with the plug boot 58 movable with respect to plug body 12. An exemplary moveable plug boot is described in U.S. Pat. No. 6,863,556, the entire contents of which are incorporated herein by reference. A similar boot 58 may be used in the embodiment in FIG. 5.

The contact pad 55 is electrically connected to sensing conductor 14 through known techniques such as crimping, soldering, an IDC, etc. When the plug 50 is mated with an outlet, the boot 58 may be slid forward towards contacts 11 to place the contact pad 55 in electrical contact with an outlet contact pad (FIG. 7) used in connectivity detection systems. Retention features on boot 58 can maintain the contact pad 55 in contact with the outlet contact.

FIG. 6 illustrates a contact pad 65 in an alternate embodiment of the invention. Contact pad 65 is a conductive member (e.g., copper) secured to the plug housing 12 and electrically connected to sensing conductor 14. The contact pad 65 may be formed from a bent piece of conductive sheet material and secured to the plug housing 12 by wrapping the contact pad 65 around the plug housing. Mechanical features on the contact pad (e.g., prongs) may be used to secure the contact pad 65 to the plug housing.

The contact pad 65 is electrically connected to sensing conductor 14 through known techniques such as crimping, soldering, an IDC, etc. Integrally formed with the contact pad 65 is an extension 66, which includes a z-shaped section 67 to provide spring force. An arcuate section 68 is provided to prevent the plug 60 from snagging on other wires with the plug 60 is pulled through installation areas. Extension 66 makes electrical contact with an outlet contact pad (FIG. 7) used in the connectivity detection systems. Extension 66 is sized and shaped to provide a spring force so that when the plug 60 is mated with an outlet, extension 66 applies a spring force to maintain physical and electrical contact with the outlet contact.

FIG. 7 illustrates an outlet contact in a connectivity detection system. An outlet 100 includes an opening 102 for receiving a plug such as that shown in FIGS. 1-6. An outlet contact pad 104 is, for example, a conductive pad (e.g., copper) electrically connected to a connectivity detection system 106. The outlet contact pad 104 may be positioned in a different location depending upon the nature of plug used. The plugs of FIGS. 1-6 all include components to place the outlet contact pad 104 in electrical connection with sensing conductor 14.

Embodiments of the invention improve the strength and durability of the contact with the sensing conductor 14, reducing the possibility of damage to the contact pad. The contact pad is preferably formed from a metal conductive sheet which simplifies the contact and reduces time and cost to manufacture. This eliminates the need for overmolded, clip on or other proprietary plastic boots required to hold a spring-load pin. Embodiments also eliminate the need for solder to connect the sensing conductor. Embodiments of the invention improve manufacturability patch cords and jumpers and reduce cost of patch cords and jumpers versus existing cords using spring-loaded pin technology.

Embodiments have been described with respect to copper connectors having eight contacts such as the RJ-45 type connector. It is understood that other types of wire patch cords (e.g., coaxial cable) having a sensing conductor may be used to detect port connectivity as disclosed herein. Furthermore, non-wire patch cords (e.g., fiber optic connectors) may include a sensing conductor and be used to detect port connectivity as disclosed herein.

All the above described embodiments may be equipped with a strain relief boot as shown in FIG. 5. As shown in FIG. 5, a cable passed through the plug boot to provide strain relief.

While the invention has been described with reference to exemplary embodiments, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiments disclosed for carrying out this invention.

What is claimed is:

1. A plug comprising:
a plug housing;
a plug boot surrounding the plug housing;
a cable passing through the plug boot;
a contact pad being placed in electrical connection with an outlet contact pad in a connectivity detection system;
a sensing conductor electrically connected to the contact pad, the sensing conductor running along the cable.

2. The plug of claim 1 wherein:
the contact pad is electrically connected to the sensing conductor through one of crimping, soldering or an insulation displacement contact.

3. The plug of claim 1 further comprising:
an extension establishing electrical contact between the contact pad and the outlet contact in the connectivity detection system.

4. The plug of claim 3 wherein:
the extension is a z-shaped element integrally formed with the contact pad.

5. The plug of claim 3 further comprising:
a coil integrally formed between the contact pad and the extension, the coil providing a spring force to the extension.

6. The plug of claim 1 further comprising:
conductive arms establishing electrical contact between the contact pad and the outlet contact in the connectivity detection system, the conductive arms moving relative to plug housing.

7. The plug of claim 1 wherein:
the contact pad is mechanically secured to plug housing.

8. The plug of claim 1 wherein:
the contact pad is mechanically secured to plug boot.

9. The plug of claim 8 wherein:
the plug boot moves relative to the plug housing to place the contact pad in electrical contact with the outlet contact in the connectivity detection system.

10. The plug of claim 1 wherein:
the plug housing includes a plurality of plug contacts for engaging contacts in an outlet.
